(19) United States
(12) Patent Application Publication
(10) Pub. No.: US 2024/0258775 A1
(43) Pub. Date: Aug. 1, 2024

(54) CABLE PROCESSING APPARATUS WITH ROTATING TOOLS

(71) Applicant: Schleuniger AG, Thun (CH)

(72) Inventors: Wolfgang FISCHER, Zug (CH); Reto APPENZELLER, Thun (CH); Jörg RYCHENER, Steffisburg (CH)

(73) Assignee: Schleuniger AG, Thun (CH)

(21) Appl. No.: 18/565,629

(22) PCT Filed: May 9, 2022
(86) PCT No.: PCT/IB2022/054266

§ 371 Date: Nov. 30, 2023

(30) Foreign Application Priority Data
May 31, 2021 (EP) 21176945.0

(51) Int. Cl. H02G 1/12; H02G 1/00

(52) U.S. Cl. CPC H02G 1/1265; H02G 1/005; H02G 1/127

(57) ABSTRACT

A cable processing apparatus comprising a tool holder for accommodating a group of at least two first tools for processing a cable. The tool holder is rotatably mounted about an axis of rotation and the at least two first tools can be moved relative to the tool holder for advancing the first tools for cable processing. A tool holder drive device rotationally driving the tool holder and a first drive device for moving the first tools relative to the tool holder are provided. At least one additional/second tool is arranged in the tool holder and can be moved relative to the tool holder. The at least one second tool can be moved independently of the first tools by way of a second drive device. A method for manufacturing a cable using a cable processing apparatus.

The invention relates to a cable processing apparatus with rotating tools according to claim 1 and a method for manufacturing a cable according to claim 13.

Rotatably movable cable processing apparatuses, which are primarily used for processing or stripping multi-layer cables such as coaxial cables or double-sheathed cables, but also other cables and wires, are known. Typically, stripping is carried out in stages. In most cases, a first rotary incision with a stripping knife cuts through the outer sheathing and/or the shielding, whereupon the incised layers can be immediately removed. During or afterwards, a film or internal insulation such as, for example, a dielectric in coaxial cables is cut as far as the inner conductor and can then be partially or completely removed. The entire cable is then cut through.

DE 10 2020 207 962 A1 discloses a cable processing apparatus with two tool groups in a rotatably movable stripping head, which are moved via a common drive device.

The first tool group comprises incising knives for cutting into a cable and the second tool group comprises slicing knives for cutting through a cable. The tools are moved by means of link guides.

This known solution has the disadvantage that both tool groups always move at the same speed, depending on the link configuration. This leads to reduced cutting quality in some types of cables.

WO 2020/119916 A1 discloses a cable processing apparatus with a tool group, wherein the drive kinematics for the feed movement of these tools is designed to be particularly simple.

It is the object of the present invention to eliminate one or more disadvantages of the prior art. In particular, the object is to provide an improved cable processing apparatus in which the precision with the first tool is still ensured and the processing speed with the second tool is increased.

At least some of the aforesaid objects are solved by the features of the independent claims. Advantageous further developments are set out in the figures and in the dependent claims.

A cable processing apparatus according to the invention comprises a tool holder for accommodating a group of at least two first tools for processing a cable, wherein the tool holder is rotatably mounted about an axis of rotation and the at least two first tools can be moved relative to the tool holder for delivering the first tools for cable processing. A tool holder drive device for rotatably driving the tool holder and a first drive device for moving the first tools relative to the tool holder are provided, and at least a second tool is arranged in the tool holder for processing the cable and can be moved relative thereto. The at least one second tool can be moved independently of the first tools by means of a second drive device.

In one embodiment, the cable processing apparatus comprises a tool holder for receiving a group of at least two first tools for processing a cable, wherein the tool holder is rotatably mounted about an axis of rotation and the at least two first tools can be moved relative to the tool holder for delivering the first tools for cable processing, and a tool holder drive device for rotatably driving the tool holder and a first drive device for moving the first tools relative to the tool holder are provided, and at least a second tool for processing the cable is arranged in the tool holder and can be moved relative thereto, wherein the at least one second tool can be moved independently of the first tools by means of a second drive device, and wherein the second drive device is arranged in a fixed position on the cable processing apparatus.

The cable processing apparatus can be an independent machine or a part or a station of an entire machine, so that the cable processing apparatus can be produced inexpensively and can be used flexibly. The movement of the first two tools can be a linear movement or a rotating movement or a combination of a linear and a rotating movement. The present cable processing apparatus enables improved processing of the cable to be processed, wherein the processing quality in particular is increased since the cable end of the cable is precisely configured with the aid of the first two tools. For example, the at least one second tool is a slicing knife for cutting through the cable, a blunt pizza knife for setting up a shielding braid, a knife with special cutting edges for removing a film residue, or a heated tool for melting a cable sheathing or a film. The two tool groups enable at least two different and independent processing steps at the cable end of the cable. The different drive devices enable simple and precise driving of the tool holder and simple and precise feeding of the tools when processing the cable end of the cable. The feeding of the first tools in the knife holder is independent of the feeding of the at least one second tool, so that the precision with the first tool is still ensured and the processing speed with the second tool is increased.

The two tool groups can be arranged in the tool holder in such a manner that the tool holder absorbs the processing forces when processing the cable. The processing forces can comprise axial forces and/or radial forces. The tool holder can be positioned by means of the tool holder drive device at a predefined position relative to the axis of rotation, which is required depending on the cable type or machining process.

Preferably, at least one of the tools is designed as a knife for cutting into the cable. For example, the knife cuts into a cable sheathing so that the sheathing can then simply be removed.

The first tools are preferably designed as incising knives for cutting into a sheathing of the cable. The sheathing of a cable has different pcordrties depending on the cable type (conductor cross-section, sheathing material, etc.), so that depending on the type of cable to be processed, it is advantageous to install a dedicated incising knife. A separate drive device for the knife for incision increases the precision during incision. The present cable processing apparatus enables improved processing of the cable to be processed when cutting into the cable, wherein the incision quality in particular is increased since the depth of cutting into the sheathing can be precisely reproduced with the aid of the optimally dimensioned drive devices.

Alternatively or additionally, the first tools are designed as incising knives for cutting into a film of the cable.

The cable films are extremely thin, so that the incising knife has suitable high-precision blades to only cut the extremely thin film. A separate precise drive device for the two incising knives enables an improved, precise cutting quality in the extremely thin films. Any undesired cutting into a layer arranged under the film is prevented.

Alternatively or additionally, the first tools are designed as incising knives for cutting into a shielding of the cable. The shielding of the cables is typically made of electrically conductive materials such as aluminium, so that the incising knife has suitable robust cutting edges to minimize wear. In order to further minimize wear on the incising knives and to delay knife replacement, a precise driving with a dedicated drive device is advantageous.

Alternatively or additionally, at least one of the tools is designed as a knife for cutting through the cable. For example, the knife cuts through the cable. A separate drive device for the knife for cutting through increases the processing speed when cutting. The present cable processing apparatus enables improved processing of the cable to be processed, wherein in particular the cutting quality is increased, and the cut-through edge at the cable end of the cable is precisely designed. The two tool groups enable at least two different and simultaneously independent cutting steps at the cable end of the cable. The different drive devices enable simple and precise driving of the tool holder and simple, independent and rapid delivery of the cutting tools when cutting in and/or cutting through the cable end of the cable.

Preferably, the at least one second tool is designed as a slicing knife for cutting through the cable. The present cable processing apparatus enables improved processing of the cable to be processed, wherein the cutting quality in particular is increased since the cut-through edge at the cable end of the cable is precisely configured. For optimal cutting quality and high processing speed, it is advantageous if one tool group can move particularly slowly and precisely and the other tool group can move particularly quickly. For example, the slicing knives should move much faster in the feed direction than the incising knives.

Alternatively, the at least one second tool has a disk-shaped blade, which is rotatably mounted via a further axis of rotation, preferably parallel to the main axis of rotation, also called a “blunt pizza knife”. With the aid of such a tool, a shielding braid is not cut, but particularly uniformly plastically deformed so that it is uniformly (pre-) set up for further processing steps (as described in DE 102020207937 A1).

Alternatively, the at least one second tool is a heatable tool, so that a film or a sheathing of the cable can be thermally processed, in particular melted away.

Alternatively, the at least one second tool is an axial knife for simply cutting away a film residue, for example from a high-voltage cable.

The separate drive device for the second tools mentioned previously enables the cable or the cable end to be processed quickly, so that the productivity in the cable processing process is increased and waste is minimized.

The cutting edges of the slicing knife are preferably V-shaped. The blades or the processing surfaces of the slicing knife are aligned with each other in a V-shape so that the two blades face each other. V-shaped blades or

processing surfaces enable the cable to be cut through with a largely planar cutting surface.

Preferably, the processing surfaces of the first tools and the processing surfaces of the at least one second tool are arranged in the same plane. Due to the arrangement in the same plane, both cuts can be made in quick succession without requiring a large movement of the cable relative to the tool holder. This saves processing time and improves precision.

Preferably, a further second tool is provided, the processing surface of which is arranged in the same plane as the processing surface of the second tool. The cable can be processed symmetrically using the at least one second tool and the further second tool, thereby preventing an undesirable deformation of the cable due to an asymmetrical force input. This ensures high processing precision. The two second tools can be moved independently of the first tools with the aid of the second drive device, so that the processing speed and precision are further improved.

Preferably, at least one passive force element is provided in the tool holder in order to move at least one of the second tools into a first position. The open position is defined here in the present case as the first position, i.e. the position in which the at least one second tool is arranged at the maximum distance from the axis of rotation in the tool holder. This second tool is held stably and reproducibly in the first position when the two first tools process the cable. In addition, both second tools can each be transferred to a passive force element in their first positions and are held stably in their first positions. For example, the passive force elements are a spring, such as a compression spring, or a magnet.

Preferably, the second drive device for moving the second tool comprises at least one actuating plunger for actuating at least one contact surface configured for this purpose on the second tool. For this purpose, this second tool has a contact surface which is arranged opposite the processing surface on the second tool, wherein the contact surface is arranged in particular on the end face of this second tool. The second tools can thus be moved quickly and reproducibly from the first position (open) into at least a second position. The second position (closed) is defined as a position of the at least one second tool or the two second tools, in which the two second tools, depending on the processing step, touch the cable, or penetrate into the sheathing, the shielding, the film or into the conductor or cut through the cable. Between the first position and the second position of the second tools there are countless third positions in which, depending on the use, the second tools can be positioned with the aid of the second drive device.

In particular, the actuating plunger is arranged in a fixed position on the cable processing apparatus, so that the actuating plunger for the at least one second tool does not rotate with the at least one second tool. As a result, the actuating plunger can be driven with a simple power supply without a rotary feedthrough. In particular, the actuating plunger is arranged adjacent to the tool holder and separated from the tool holder. This reduces the overall weight of the tool holder, so that the flywheel mass when rotating the tool holder is reduced. As a result, the tool holder can be positioned more precisely with the first drive device so that the processing of the cable with the first tools is made more precise. Due to the lower flywheel mass, the energy consumption of the drive device is also reduced.

In a preferred manner, the tool holder drive device and the second drive device for the second tools are arranged such that the second tools are driven in a non-rotating mode of the tool holder. According to the findings of the inventor, by driving the second tools (e.g. when cutting through) in a non-rotating mode of the tool holder, i.e. when the tool holder is stationary, any torsion or twisting of the cable is prevented whilst the second tools are being used. This is particularly the case when the at least one second tool is a V-shaped slicing knife. Operating the tools in non-rotating mode therefore advantageously improves the quality of the cable being processed.

Alternatively or additionally, the second drive device is configured as a parallel gripper, so that the two second tools can be transferred synchronously and rapidly from the first position to their second position.

The second drive device is preferably configured as a pneumatic parallel gripper, so that the at least one second tool can be reproducibly and quickly transferred from the first position into the second position.

Advantageously, the first two tools can be moved from a first position (open) to a second position (closed) with the aid of the first drive device. The open position is defined here in the present case as the first position, i.e. the position in which the first tools are arranged at the maximum distance from the axis of rotation in the tool holder. A position of the first tools is defined as the second position (closed) in which, depending on the processing step, the first two tools touch the cable or penetrate into the sheathing, the shielding, the film or the conductor. Between the first position and the second position of the first tools there are countless third positions in which, depending on the use, the first tools can be positioned with the aid of the first drive device.

Preferably an adjusting ring is provided which can be moved relative to the tool holder. This movement is preferably a rotation around the axis of rotation, so that a space-saving movement of the adjusting ring about the axis of rotation is possible and has a compact structure.

Alternatively, this movement is a linear displacement parallel to the axis of rotation. This design requires a little more space than the design with rotation of the adjusting ring, but only one toothed belt is required for this. The two drives for the rotation and the feed movement of the first tools are also independent of each other, which is why complex electrical synchronization (as in DE 10 2020 207 962 A1) or complex mechanics (as in WO 2020/119916 A1) is not necessary.

Preferably, at least one drive element is provided, which is arranged on the adjusting ring or is operatively connected to a surface of the adjusting ring in order to easily and precisely convert the rotary movement of the adjusting ring relative to the tool holder into a linear movement of one of the first two tools. For example, the at least one drive element comprises a connecting rod, which is rotatably mounted in the adjusting ring and in one of the first tools. In this design, all the forces are transmitted very directly, which means that the backlash is very low. A maximum precision is thus achieved.

Alternatively, the drive element can be a flexible element, for example a cord, a band, a belt or a chain and is attached to the at least one first tool and to the adjusting ring configured as a disk; or enters into a form-fitting operative connection with these other elements of the drive with the aid of a toothed structure. Deflections are provided in the tool holder to guide the drive element so that the desired conversion of the movement is achieved. These deflections are preferably designed as rollers in order to minimize friction losses. In contrast to the variant with a connecting rod, due to the drive with the aid of flexible drive elements and deflectors a constant transmission ratio is achieved, as is also the case with the variants with gears or link guides described hereinafter. Compared to these alternatives, this drive has less backlash, which improves the precision. Furthermore, the first tools can be spring-mounted in one direction in the tool holder. As a result, the drive element only has to apply tensile forces in one direction and can therefore be shorter and simpler, with fewer deflectors. Also the deflectors s can be arranged in such a manner that all the tools can be moved with just one belt.

Alternatively, the drive element can also be a gear, with a toothed structure that matches a toothed structure in at least one first tool and in the adjusting ring (outer or inner surface), configured as a gear. The place of action of the operative connection between the drive element and the tool here is the location where the meshed teeth of the gear wheel or pinion and the toothed structure or rack on the tool touch each other. In contrast to the other embodiments, where the place of action is defined by a swivel joint and/or the fastening means for a belt, here the place of action moves along the tool when the gear wheel rolls on the rack in the local coordinate system of the tool, but remains in approximately the same place in the local coordinate system of the tool holder. The same applies to the place of action of the operative connection between the drive element and the adjusting ring. The drive with gear wheels requires very few parts and is therefore very space-saving. Here too, the transmission ratio is constant.

Alternatively, the drive element can also be a sliding body or a sliding bearing, matching an adjusting ring configured as a camshaft or link guide. This design can be realized very compactly.

In the aforesaid embodiments, the movement of the adjusting ring with the aid of the drive element causes a linear movement of the at least one first tool. The first tools can thus be moved easily and precisely from a first position into at least a second position with the aid of a movement of the adjusting ring.

Preferably, the cable can be moved axially along the axis of rotation relative to the tool holder. The cable can thus be fed centred to the tool holder, so that a rotationally symmetrical processing of the cable is possible. The axial movement of the cable can also be carried out with delivered tools, with the result that partially incised outer layers can be removed.

In particular, the cable is moved along the axis of rotation with the aid of a gripper with two gripper jaws, which is moved by means of a spindle drive. The gripper is preferably designed as a pneumatic parallel gripper.

Alternatively, the gripper for the cable can remain in a fixed position and the rotating elements of the cable processing apparatus can be moved axially along the axis of rotation, preferably again with a spindle drive. As an alternative to the spindle drive, another linear drive can also be used, for example with a toothed belt or rack.

Instead of a gripper, the cable can also be fixed and moved at the same time in a conveyor device with driven rollers.

In this case only the cable moves through motorized rotation of the driven rollers.

Preferably a group of third tools is provided which can be delivered radially to the axis of rotation. The third tools can advantageously be moved from a first position (open) into a second position (closed). The open position is defined here as the first position, i.e. the position in which the third tools are arranged at the maximum distance from the axis of rotation in the tool holder. The second position (closed) is defined as a position of the third tools in which, depending on the processing step, the two third tools touch the cable or penetrate into the sheathing, the shielding, the film or into the conductor. Between the first position and the second position of the third tools there are countless third positions in which, depending on the use, the third tools can be positioned or moved, preferably with the aid of a third drive device. To move the third tools using the third drive device, drive kinematics can be used as described in DE 10 2020 207 962 A1. Such a cable processing apparatus then again has the associated disadvantages, but now even enables three different processing options with a very compact design.

Preferably, however, the third drive device is arranged in the tool holder, so that a compact design is provided and the processing paths from the first position of the at least one second tool into the second position are shortened and the processing speed is thereby increased.

A power supply is preferably provided, which is connected to the drive device via hoses. The power supply can be an electrical power supply, a hydraulic and/or a pneumatic power supply, which supplies the third drive device with electrical power or with a fluid (compressed air or oil).

A rotary feedthrough for the hoses is preferably provided. Alternatively or additionally, co-rotating sensors are provided in the tool holder and/or in the drive devices, for example for monitoring the first and/or second positions of the respective tools. The rotary feedthrough can be a simple rotary feedthrough or a hollow shaft rotary feedthrough or a multi-channel rotary feedthrough with at least one slip ring, especially if double-acting pneumatic parallel grippers are provided and/or co-rotating sensors are provided. Thus the hoses and/or electrical cables are not unintentionally wound up due to the rotation of the tool holder.

Preferably, the third drive device in the tool holder is designed to be pneumatic, so that a cost-effective and lightweight additional drive device is provided and the overall weight of the tool holder is small in order to improve the precision when rotating the tool holder.

The third drive device is preferably designed as a single-acting pneumatic cylinder. By using single-acting pneumatic cylinders in combination with passive force elements, only a single compressed air channel is required in the rotary feed through, which enables a particularly cost-effective and compact design.

The first tools are preferably designed as incising knives, the at least one second tool as a slicing knife and the third tool as a blunt pizza knife for setting up a shielding braid.

There are preferably several second tools, more preferably also several third tools. Further preferably, of all three tools or tool groups there are precisely two in each case and even more preferably the processing surfaces of all the tools are in the same plane or at least closely adjacent. Thus, cable ends of complex cable types can be processed quickly and precisely, whereby the cutting quality is improved, at least when incising. Processing the cable end with the first and third tools takes place with a rotary movement of the tool holder, so that the cuts in the cable can be carried out precisely and symmetrically. The cable is processed with the at least one second tool without rotation of the tool holder, so that cutting through takes place at an increased speed.

Alternatively, the third tools can also be configured for other processing options, for example as an axial knife for removing film residues or as a removal tool (positively with a blunt knife or frictionally with a gripper) or as a heated tool for the thermal treatment (melting away) of cable layers with a low melting point. The advantages are the same as mentioned previously.

It is also possible that second groups of tools with respective drive devices are provided, whereby there is a group of first tools with a first drive device for moving the first tools, and a group of third tools with a third drive device for moving the third tools. The first tools can be moved independently of the third tools. It must be noted that the group of third tools can only comprise one third tool. In these arrangements, the group of at least one third tool therefore functions like the at least one second tool as described previously.

In an exemplary embodiment with a group of first tools and a group of third tools, the third tools comprise at least one, preferably two slicing knives for cutting through the cable. The cutting edges of the slicing knife are advantageously configured to be V-shaped. The blades or the processing surfaces of the slicing knife are aligned with respect to one other in a V-shape so that the two blades face each other. V-shaped blades or processing surfaces make it possible to cut through the cable with a largely planar cutting surface. In order to move the two slicing knives into their further position for processing the cable, the rotation of the tool holder is stopped in a predefined position. The cable is cut through afterwards without rotation of the tool holder so that the cutting through takes place at an increased speed.

In a preferred manner, the tool holder drive device and the third drive device for the third tools are arranged such that the third tools are driven in a non-rotating mode of the tool holder. According to the findings of the inventor, by driving the third tools in a non-rotating mode of the tool holder, i.e. when the tool holder is stationary, any torsion or twisting of the cable whilst the third tools are being used (e.g. when cutting through) can be prevented. This is particularly the case when the at least one third tool is a V-shaped slicing knife. Operating the tools in non-rotating mode therefore advantageously improves the quality of the processed cable.

The drive devices and sensors described here are electrically connected to a control device to exchange control data or measurement data. The control device transmits control commands to the drive devices, so that the first tools can be transferred independently of the second tools, and in particular independently of the third tools, and the tool holder can be rotated independently of the tools. Thus complex and versatile processing steps can be carried out on the cable precisely and quickly.

A cable processing machine according to the invention comprises a cable processing apparatus, as described here, so that a cable can be processed precisely and at a high processing speed.

A method according to the invention for manufacturing a cable with a cable processing apparatus, in particular a cable processing apparatus as described above, the method comprising at least the following steps:
a) providing a cable;
b) rotating a tool holder with a first drive device and rotatably processing a sheathing and/or a shielding and/or a film of a cable with a group of at least two first tools;
c) stopping the tool holder in a predefined position;
d) processing the cable using at least one second tool, wherein the at least one second tool is moved independently of the first tools with the aid of a second drive device.

Preferably, the at least one second tool is in a first position during step b). This prevents any unintentional damage to the cable whilst processing the cable with the first tools.

In particular, the at least one second tool is passively spring-mounted in the first position and is therefore held reproducibly and stably in the first position.

Preferably, after step b), the tool holder is moved relative to the cable along the axis of rotation, wherein the first tools are located in a third position. Here, a third position is defined in the present case as a position of the first tools in which the sheathing of the cable is removed from the conductor using the first two tools.

Further advantages, features and details of the invention are obtained from the following description, in which exemplary embodiments of the invention are described with reference to the drawings. Lists such as first, second, third or other only serve to identify the components.

The reference list like the technical content of the patent claims and figures, is part of the disclosure. The figures are described coherently and comprehensively. The same reference numbers mean the same components, reference numbers with different indices indicate functionally identical or similar components.

In the figures:

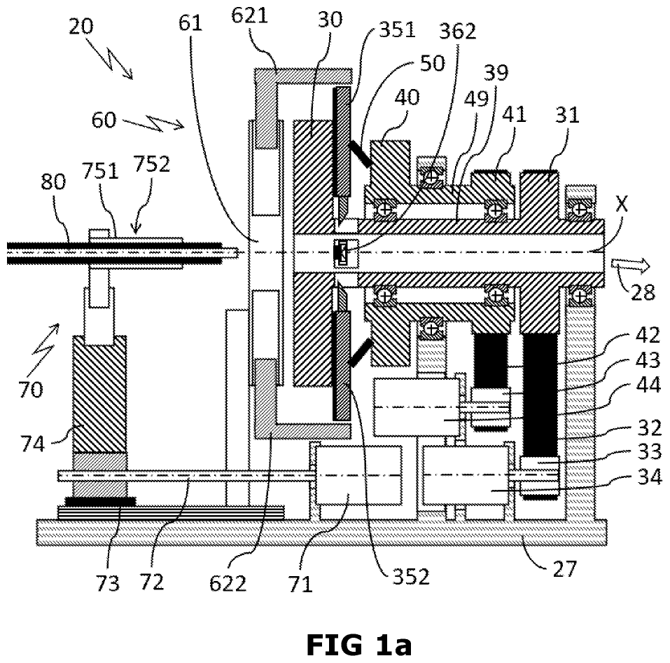

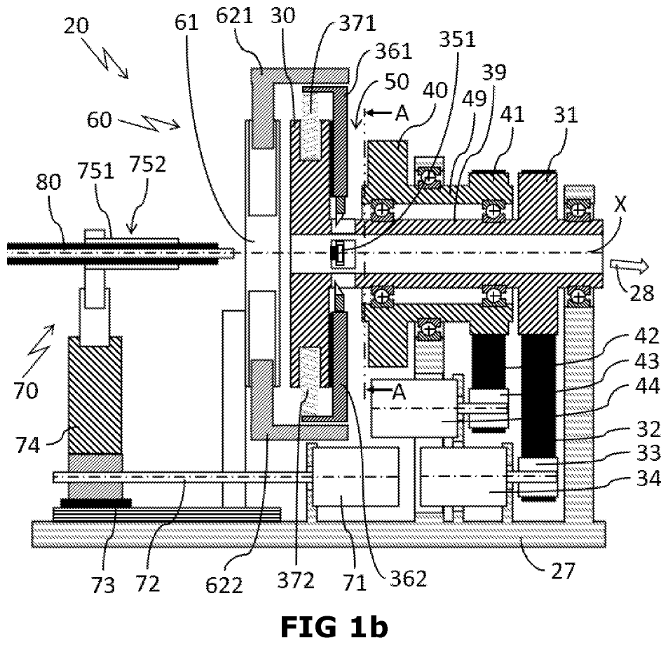

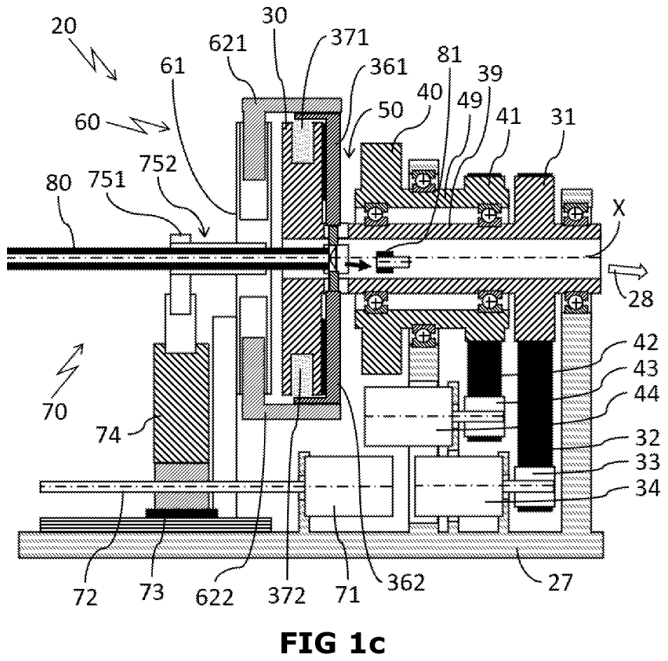

FIG. 1a shows a first embodiment of a cable processing apparatus according to the invention in a schematic sectional view, wherein first tools are shown in a first position,

FIG. 1b shows the cable processing apparatus according to FIG. 1a in a schematic sectional view, wherein second tools are shown in a first position,

FIG. 1c shows the cable processing apparatus according to FIG. 1b in a schematic sectional view, wherein the second tools are shown in a further position,

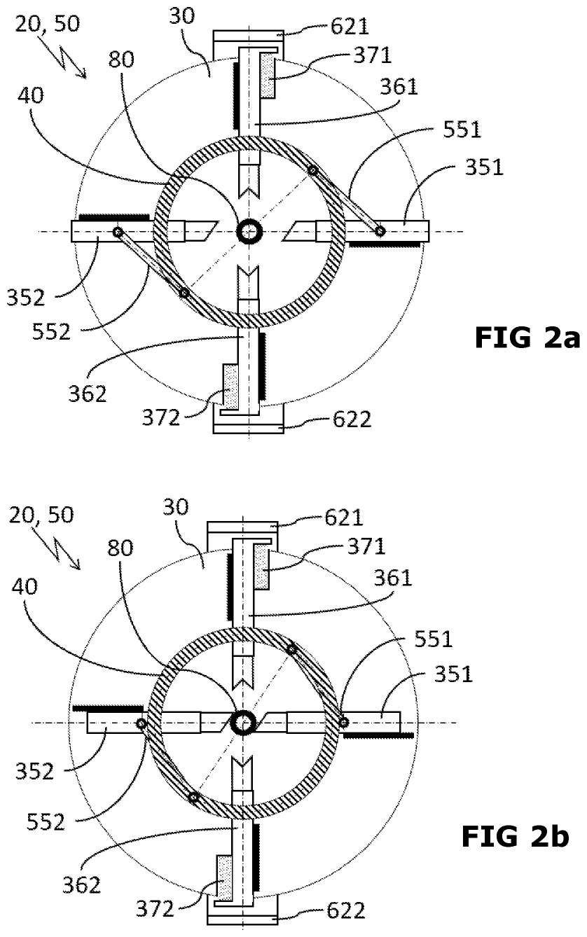

FIG. 2a shows the cable processing apparatus according to FIG. 1b in a schematic sectional view along the section line AA and in the same position as shown in FIG. 1b,

FIG. 2b shows the cable processing apparatus according to FIG. 2a with the first tools shown in a second position,

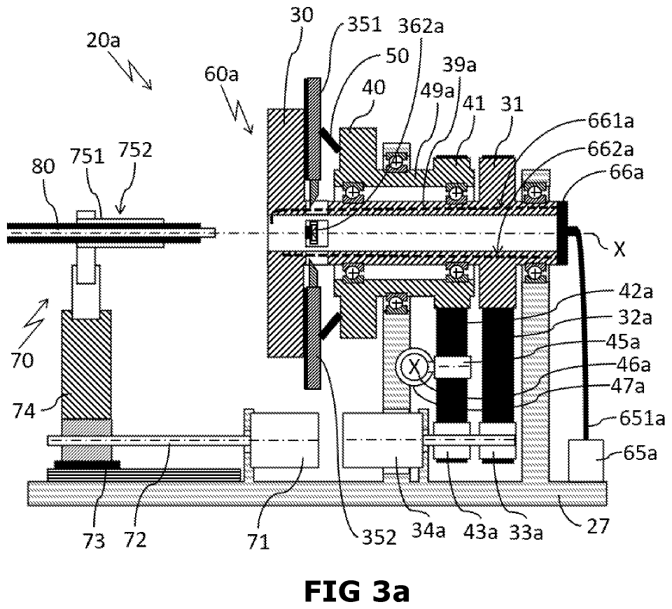

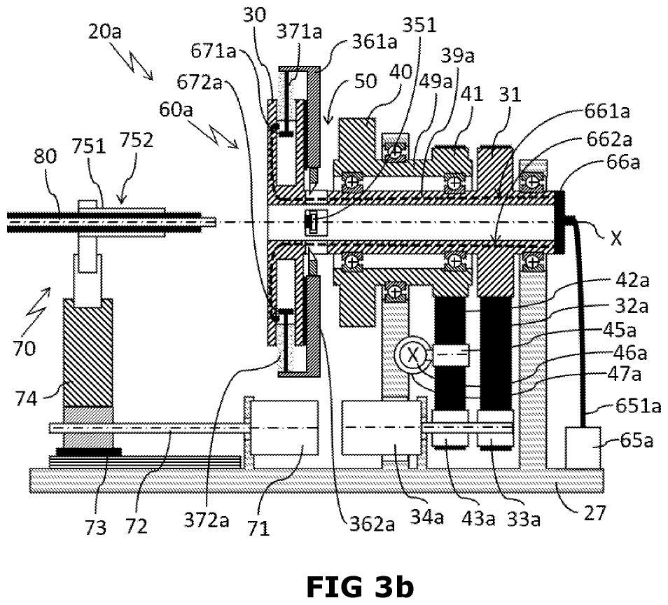

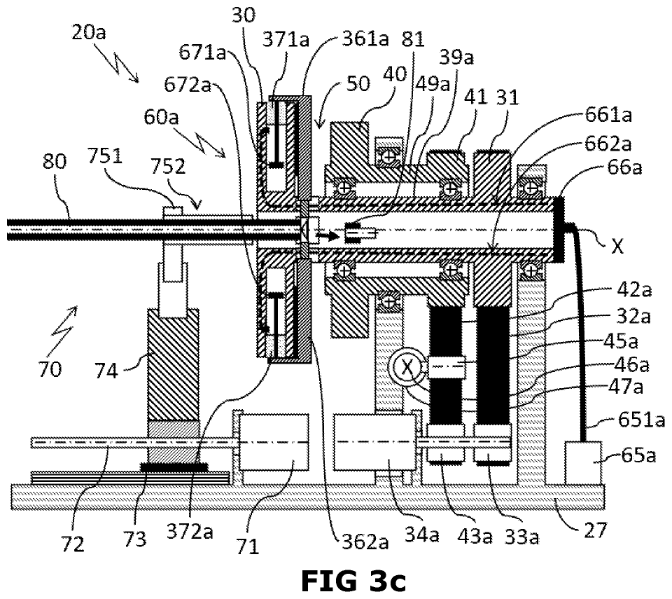

FIG. 3a shows a further embodiment of a cable processing apparatus according to the invention in a schematic sectional view, wherein first tools are shown in a first position,

FIG. 3b shows the cable processing apparatus according to FIG. 3a in a schematic sectional view, wherein second tools are shown in a first position,

FIG. 3c shows the cable processing apparatus according to FIG. 3b in a schematic sectional view, wherein the second tools are shown in a further position, and

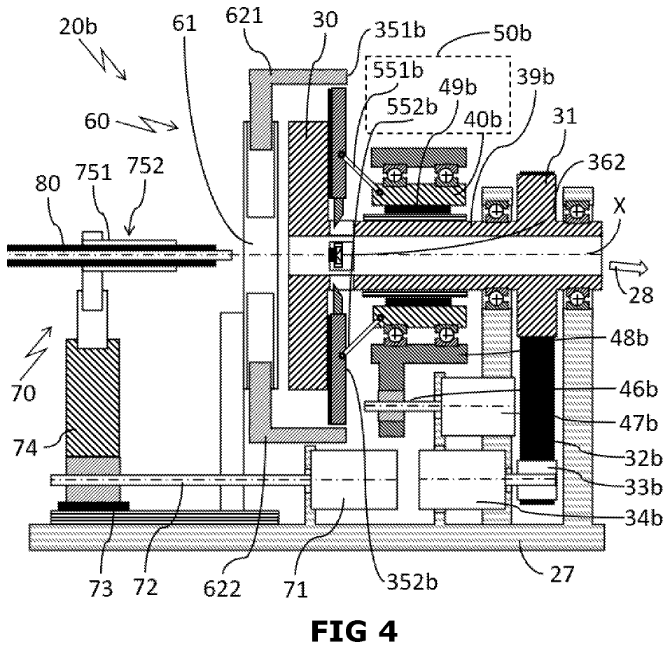

FIG. 4 shows a further embodiment of a cable processing apparatus according to the invention in a schematic sectional view, wherein first tools are shown in a first position.

FIG. 1a to FIG. 1c show a first embodiment of a cable processing machine with a cable processing apparatus 20 having a connecting structure 27 and a tool holder 30 mounted therein so as to be rotatable about the axis of rotation X, in which a first group of first tools 351, 352 and a second group of second tools 361, 362 are mounted to be displaceable linearly and perpendicularly to the axis of rotation and therefore with an axial drive 70 for axially displacing the cable 80 along the axis of rotation X. The linear guides in the tool holder 30 or the tools 351, 352, 361, 362 are arranged symmetrically about the axis of rotation X.

The axial drive 70 consists of an axial drive device 71, a spindle 71, a linear guide element 73, a cable gripper 74 and two gripper jaws 751, 752 attached thereto. The cable 80 is fixed in the gripper jaws 751, 752 of the cable gripper 74, which is designed as a pneumatically driven parallel gripper. The cable gripper 74 is connected to the linear guide element 73, which is guided on a guide rail attached to the connecting structure 27 and thus enables axial movement parallel to the axis of rotation X. This movement is driven by a spindle nut in the area of the guide element 73 and the spindle 72, which is rotated with the aid of the axial drive device 71. This axial drive device 71 is designed as an electrically driven motor with a rotary encoder and flanged planetary gear, and is electrically connected to a control device (not shown), similarly to all other motors, sensors and valves for pneumatic drives listed here.

Alternatively to the drive with a spindle 72, a rack or toothed belt drive can also be used to move the cable gripper 74. The cable gripper 74 can also be configured as an angle gripper. In addition, further drives and/or guides for movements of the cable 80 transversely to the axis of rotation X can also be provided. Alternatively to the axial movement of the cable gripper, its gripper jaws can also comprise rollers or similar drive elements and thus convey the cable directly. This design is advantageous for swivel arm machines. Alternatively, it is also possible to move the tool holder axially together with its rotatable mounting and all its drives. This design is advantageous for simple transfer or rotary transfer machines in which the cable is moved in a non-axially displaceable cable carrier between different cable processing apparatuses.

The tool holder 30 is rotatably mounted on the connecting structure 27 and connected via an inner hollow shaft 39 to a tool holder drive wheel 31, designed as a tool holder toothed belt wheel 31. This tool holder toothed belt wheel 31 is connected via a tool holder toothed belt 32 and a tool holder toothed belt pinion 33 to a tool holder drive device 34, again designed as an electrically driven motor with a rotary encoder and flanged planetary gear, and electrically connected to a control device (not shown). The tool holder 30 can thus be actively rotated by a motor with the aid of control signals.

In the tool holder 30, a first group of first tools 351, 352 and a second group of second tools 361, 362 are mounted so that they can be displaced linearly in the radial direction to or from the axis of rotation X. The first group of first tools 351, 352 is moved here with the aid of a first drive 50 and the second group of second tools 361, 362 is moved with the aid of a second drive 60.

The first drive 50 generates a required radial linear movement of the first tools 351, 352 from a relative rotation between the tool holder 30 and an adjusting ring 40. This first drive 50 is shown schematically in FIG. 1a with two thick lines, an exemplary embodiment is shown in FIG. 2.

The adjusting ring 40 is connected via an outer hollow shaft 49 to an adjusting ring drive wheel 41, designed as an adjusting ring toothed belt wheel 41. The outer hollow shaft 49 and the inner hollow shaft 39 are rotatably mounted with respect to one another and to the connecting structure 27. The adjusting ring toothed belt wheel 41 is connected via an adjusting ring toothed belt 42 and an adjusting ring toothed belt pinion 43 to a first drive device 44, in turn designed as an electrically driven motor with a rotary encoder and flanged planetary gear, and electrically connected to a control device (not shown). The adjusting ring 40 can thus also be actively rotated by a motor with the aid of control signals.

The two drive devices 34, 44 for the tool holder 30 and the adjusting ring 40 are here controlled in such a manner that they rotate synchronously in normal operation and execute a relative movement with respect to one another in order to deliver the first group of first tools 351, 352.

The second drive 60 consists of a second drive device 61 and two actuating plungers 621, 622 moved by it, which actuate the second tools 361, 362. The second drive device 61 is designed as a pneumatically driven parallel gripper and is connected to the connecting structure 27, i.e. does not rotate together with the tool holder 30. The actuating plungers 621, 622 are integrated into or attached to the gripper jaws of this parallel gripper 61.

The second tools 361, 362 are guided linearly in the radial direction in the tool holder 30, and are each connected to a passive force element 371, 372, here designed as a spring or as a cylindrical spiral compression spring. This passive force element 371, 372 ensures that the associated second tool 361, 362 is clearly fixed in a first position in the non-actuated state, but can still be brought into at least one further position with the aid of the actuating plunger 621, 622. This is shown in Figures FIG. 1b and FIG. 1c:

In FIG. 1b, the two second tools 361, 362 are located in their first position (open—at the maximum distance from each other). The second drive device 61 with its two actuating plungers 621, 622 is also located in its first position (open—at a maximum distance from one another or not actuated). In this position, rotation of the tool holder 30 is possible and the second tools 361, 362 always remain in their first position (open—maximum distance from each other), whereas processing the cable 80 with the first tools 351, 352 is still possible. In order to move the second tools 361, 362 into their further position for processing the cable 80, the rotation of the tool holder 30 is stopped in a predefined position, in an angular position about the axis of rotation X, in which the second tools 361, 362 and the actuating plungers 621, 622 are aligned with respect to one another (FIG. 1b, FIG. 1c, FIG. 2a, FIG. 2b).

In this angular position, the second drive device 61 is now transferred to its further position, whereby the two actuating plungers 621, 622 are moved, come into operative connection with the two second tools 361, 362 and move them radially inwards, whereby the cable 80 is processed or is cut.

In the example shown of the cable processing apparatus 20, the second tools 361, 362 are designed as slicing knives, whereby the cable 80 is cut through and a cable piece 81 is separated from it. The first tools 351, 352 are designed as incising knives, which cut into the cable in its outer layers and partially remove these layers, for example a sheathing, a film or a shielding. In order to remove this separated material, a suction device 28 is used, shown here only schematically as a block arrow.

Alternatively or additionally, the second drive device 61 can also be designed as an electric parallel gripper, or the actuating plungers 621, 622 can be moved with independent drive devices, preferably designed as simple pneumatic cylinders and actuated by a common valve. This enables a space-saving design and/or more than two actuating plungers and therefore more than two second tools. An electric drive is also possible here, preferably with the aid of electromagnets, preferably in a plunger design. Other types of springs can also be used for the passive force elements 371, 372, for example tension springs or rolling or constant force springs. The use of permanent magnets is also possible. Instead of a linear mounting of the tools in the tool holder, a rotatable mounting is also possible, or a mixed form (one group of tools mounted linearly, the other group mounted rotatably).

FIG. 2a and FIG. 2b show a schematic sectional view of the first drive 50 in the cable processing apparatus 20 from FIG. 1, according to the sectional plane AA shown in FIG. 1b.

In FIG. 2a, both groups of tools 351, 352, 361, 362 are in their respective first position (open-maximally spaced apart from each other), i.e. as shown in FIG. 1b. In FIG. 2b, the first group of first tools 351, 352 is delivered radially in the direction of the cable 80 by rotation of the adjusting ring 40 relative to the tool holder 30 and is thus located in the second (closed/delivered) position. The two drive elements 551, 552, here designed as connecting rods, are used to convert the relative rotation into the desired linear radial movement. These connecting rods 551, 552 are each rotatably mounted on the adjusting ring 40 and on the respective first tool 351, 352 and thus transmit the movement of the adjusting ring 40 to the tools 351, 352.

Alternatively or additionally, drive elements can also be used for this power transmission, for example gear wheels or pinions, cam rollers or plain bearings, or belts, cords or chains, provided that the alternative adjusting rings, tools and/or tool holders are designed accordingly, for example as a gear wheel and rack, link or cam disk ring, or with deflection rollers and/or additional springs on the tool holder. A rotatable mounting of the tools in the tool holder is also conceivable.

The first group of first tools 351, 352 is designed as an incising knife with a slightly oblique cutting edge, which minimizes unwanted vibrations of the knife when cutting the cable 80 and thus ensures optimal precision and cutting quality. The second group of tools 361, 362 is designed as a slicing knife with V-shaped blades, which make it possible to cut through the cable 80 with a largely planar cutting surface, even without rotation of the tools 361, 362 about the axis of rotation X.

FIG. 3a to FIG. 3c show a further embodiment of a cable processing machine with a cable processing apparatus 20a, similar to the cable processing apparatus 20 from FIG. 1, with an alternative (second) drive 60a for the movement of the second group of (second) tools 361a, 361b and an alternative drive kinematics for the rotation of tool holder 30 and adjusting ring 40. Alternatively, the cable processing apparatus could additionally comprise a third group of third tools 361a, 361b, and the drive 60a could be used for moving the third tools 361a, 361b.

The alternative drive 60a (visible in FIG. 3b and FIG. 3c) consists of the two drive devices 671a, 672a, the (compressed air) hoses 651a, 661a, 662a, the rotary feedthrough 66a and the valve 65a. The valve 65a is part of a valve battery and is electrically connected to a control device (not shown). With the aid of control signals, the compressed air hose 651a connected thereto can either be supplied with compressed air or depressurized. The other end of this compressed air hose 651a is connected to the non-rotating part of the rotary feedthrough 66a. The co-rotating part of the rotary feedthrough 66a is connected to the inner hollow shaft 39, which connects the tool holder 30 to the tool holder drive wheel 31. There, with the aid of the compressed air hoses 661a, 662a, the compressed air is passed to the two drive devices 671a, 672a, designed as single-acting pneumatic cylinders, which are arranged in the tool holder 30. These are connected to the second (or third) tools 361a, 362a and each a passive force element 371a, 372a, designed as a spring or as a cylindrical spiral compression spring. The second (or third) tools 361a, 362a are moved by the passive force elements 371a, 372a into their first position (open) when the drive devices 671a, 672a are switched to depressurized (FIG. 3b). If the two drive devices 671a, 672a are pressurized (FIG. 3c), they move the second (or third) tools 361a, 362a into the further position necessary for processing or cutting through the cable 80. By using single-acting pneumatic cylinders in combination with passive force elements, only a single compressed air channel is required in the rotary feedthrough 66a, which enables a particularly cost-effective and compact design.

Alternatively or additionally, the rotary feedthrough can also be designed as a hollow shaft rotary feedthrough, which in turn creates the possibility of a suction device similar to that shown in FIG. 1. It is also possible to use a rotary feedthrough with several compressed air channels, which in turn enables double-acting pneumatic cylinders in the drive elements. Rotary feedthroughs with slip rings for electrical signals or energy transmission are also conceivable, preferably in combination with sensors for detecting the end positions of the drive elements and/or heating elements for heating the tools for thermal treatments on the cable 80, especially a shielding film contained there.

When designing the passive force elements, all variants are again possible, as already described in FIG. 1. A rotatable mounting of the second tools is also possible.

Alternatively using two separate drive elements, three or more drive elements can also be used, or even merely a single drive element in combination with drive kinematics, which enables the synchronous delivery movement of all the second tools.

Even in the designs with the drive elements arranged in the tool holder, the drive elements can be designed electrically, preferably as electromagnets, preferably as plunger magnets. Here the rotary feedthrough is designed as a slip ring.

The drive kinematics for the rotation of the tool holder 30 and the adjusting ring 40 are also designed differently than in the cable processing apparatus 20 in FIG. 1. Both are connected via a hollow shaft 39a, 49a to respectively one toothed belt wheel 31, 41. In the further cable processing apparatus 20a however, both toothed belt wheels 31, 41 are each connected via a toothed belt 32a, 42a and a toothed belt pinion 33a, 43a to the shaft of the tool holder drive device 34a, again designed as an electric motor with a planetary gear and rotary encoder. In order to enable a relative rotation of the two toothed belt wheels 31, 41 with respect to one another, the adjusting ring toothed belt 42a is deflected with the aid of two deflection rollers 45a (only one of which is visible), which can be moved by motor transversely to the viewing direction, with the aid of a spindle 46a and a first drive device 47a.

Alternatively or additionally, the deflection rollers can also be arranged on the other toothed belt, or their linear movement can be driven differently, for example via a toothed belt or a toothed rack. Alternative drives for generating a relative rotation between the two drive wheels 31, 41 are also conceivable, for example with the aid of a differential or planetary gear.

FIG. 4 shows another embodiment of a cable processing apparatus 20b, similar to the cable processing apparatus 20 from FIG. 1, with an alternative (first) drive 50b for the delivery of the first group of tools 351b, 352b.

Here, the adjusting ring 40b is designed as an axially movable inner driver piece 40b and with the aid of a linear guide element 49b is mounted linearly displaceably along the axis of rotation X on the inner hollow shaft 39b between the tool holder 30 and the tool holder drive wheel 31. This axial movement is converted into a radial movement of the first tools 351b, 352b with the aid of two drive elements 551b, 552b. These drive elements 551b, 552b are in turn designed as connecting rods, which are rotatably mounted in the inner driver piece 40b and in the first tools 351b, 352b. The axial movement of the inner driver piece 40b is generated with the aid of a first drive device 47b, which is connected to the connecting structure 27 and in turn is designed as an electric motor with a planetary gear and rotary encoder. For this purpose, the rotary movement of this first drive device 47b is converted into a linear movement with the aid of a spindle 46b, which moves a non-rotating, outer driver piece 48b attached thereto along the axis of rotation X. The inner driver piece 40b is rotatably mounted in this outer driver piece 48b. Thus, the rotation of the tool holder 30 is not hindered, but the axially acting driving force of the first drive device 47b or the spindle 46b attached thereto can be transmitted to the inner driver piece 40b and the drive elements 551b, 552b attached thereto. In this embodiment, the at least one second tool 361, 362 can be moved with the aid of the second drive device 61 and the actuating plungers 621, 622.

Alternatively, the drive elements and the corresponding mechanical interfaces on the inner driver piece and on the first tools can also be designed as a link guide, a combination of racks and pinions, with cord, belts or chains, or other types of gears.

It is also possible to convert the axial movement into a rotation of an adjusting ring relative to the tool holder and then use a drive similar to that described in FIG. 2. The conversion of the axial movement into a rotary movement is accomplished, for example, with the aid of a spindle.

Further combinations of the different drives for the individual tool groups are also possible, also with further partial solutions described here, for example, more than two tools per tool group and/or rotatable mounting of the tools in the tool holder.

Other embodiments of the tools can also be used, for example rotating disks (pizza knives) for setting up a shielding braid, knives with special cutting surfaces for axial cuts to remove a film residue or heated tools for thermal treatments to weaken a shielding film, for example.

A method according to the invention for manufacturing a cable 80 with a cable processing apparatus, in particular a
cable processing apparatus 20, as previously described and shown for example in FIGS. 1a to 1c, comprises at least the following steps:
a) providing a cable 80;
b) rotating a tool holder 30 with the tool holder drive device 34 and rotatably processing a sheathing and/or a shielding and/or a film of a cable 80 with a group of at least two first tools 351, 352 driven by a first drive device 44;
c) stopping the tool holder 30 in a predefined position;
d) processing the cable 80 with the aid of at least one second tool 361, 362, wherein the at least one second tool 361, 362 is moved independently of the first tools with the aid of a second drive device 61.

Preferably, the at least one second tool 361, 362 is located in a first position during step b).

In particular, the at least one second tool 361, 362 is passively spring-mounted in the first position.

Preferably, after step b), the tool holder is moved relative to the cable along the axis of rotation, wherein the first tools are located in a third position.

### REFERENCE LIST

20, 20a-b Cable processing apparatus
27 Connecting structure
28 Suction device
30 Tool holder (tool flange)
31 Tool holder drive wheel (toothed belt wheel for tool holder)
32, 32a-b Tool holder toothed belt
33, 33a-b Tool holder toothed belt pinion
34, 34a-b Tool holder drive device (geared motor)
351, 352, 351b, 352b (First) tool (first group, incising knife)
361, 362, 361a, 362a (Second) tool (second group, slicing knife, V-knife)
371, 372, 371a, 372a Passive force element (spring)
39, 39a-b (Inner) hollow shaft
40 Adjusting ring
41 Adjusting ring drive wheel (toothed belt wheel for adjusting ring)
42, 42a Adjusting ring toothed belt
43, 43a Adjusting ring toothed belt pinion
44 (First) drive device (gear motor)
45a Deflection roller
46a, b Spindle
47a, b (First) drive device (gear motor)
48b (Outer) driver piece (non-rotating)
49, 49a (Outer) hollow shaft
50, 50b (First) drive (transmission)
40b Adjusting ring (axially moved, inner driver piece, co-rotating)
49b (Linear) guide element
551, 552, 551b, 552b Drive element (connecting rod)
60, 60a (Second) drive
61 (Second) drive device (actuator gripper, parallel gripper)
621, 622 Actuating plunger (gripper jaw)
65a Valve (valve battery)
651a (Compressed air) hose
66a Rotary feedthrough (pneumatic)
661a,662a (Compressed air) hose
671a, 672a (Third) drive device (pneumatic cylinder, single-acting)
70 Axial drive
71 (Axial) drive device (gear motor)
72 Spindle
73 (Linear) guide element
74 Cable gripper (parallel gripper)
751, 752 Gripper jaw
80 Cable
81 (Separated) piece of cable
A Cutting plane
X Axis of rotation (cable axis)

1-15. (canceled)

16. A cable processing apparatus (20, 20a, 20b) comprising:
A tool holder (30) for accommodating a group of at least two first tools (351, 352) for processing a cable (80),
the tool holder (30) is rotatably mounted about an axis of rotation (X) and the at least two first tools (351, 352) can be moved relative to the tool holder (30) for delivering the first tools (351, 352) for cable processing, and
a tool holder drive device (34, 34a, 34b) for rotationally driving the tool holder (30) and a first drive device (44, 47a, 47b) for moving the first tools (351, 352) relative to the tool holder (30) are provided, and
at least one second tool (361, 362, 361a, 362a) for processing the cable (80) is arranged in the tool holder (30) and can be moved relative thereto,
the at least one second tool (361, 362, 361a, 362a) can be moved independently of the first tools (351, 352) by means of a second drive device (61), and
the second drive device (61) is arranged in a fixed position on the cable processing apparatus so that it cannot rotate together with the tool holder (30).

17. The cable processing apparatus according to claim 16, wherein at least one of the tools (351, 352, 361, 362, 361a, 362a) is designed as a knife for cutting into and/or cutting through the cable (80), and preferably the first tools (351, 352) are designed as incising knives for cutting into a sheathing, a film and/or into a shielding of the cable (80).

18. The cable processing apparatus according to claim 16, wherein the at least one second tool (361, 362, 361a, 362a) is designed as a slicing knife for cutting through the cable (80), wherein the cutting edges thereof are preferably configured to be V-shaped.

19. The cable processing apparatus according to claim 16, wherein the processing surfaces of the first tools (351, 352) and the second tool (361, 362, 361a, 362a) are arranged in the same plane.

20. The cable processing apparatus according to claim 16, wherein a further second tool (361, 362, 361a, 362a) is provided, the processing surface of which is arranged in the same plane as the second tool (361, 362, 361a, 362a).

21. The cable processing apparatus according to claim 16, wherein at least one passive force element (371, 372, 371a, 372a) is provided in the tool holder (30) in order to transfer at least one of the second tools (361, 362, 361a, 362a) into a first position.

22. The cable processing apparatus according to claim 16, wherein the second drive device (61) for moving the second tool (361, 362) has at least one actuating plunger (621, 622) for actuating at least one contact surface configured for this purpose on the second tool (361, 362), wherein the actuating plunger (621, 622) in particular is arranged in a fixed position so that it cannot rotate together with the tool holder (30) and/or the further drive device (61) is configured as a parallel gripper, preferably configured as a pneumatic parallel gripper.

23. The cable processing apparatus according to claim 16, wherein a group of third tools is provided, which can be delivered radially to the axis of rotation (X) and can preferably be moved by means of a third drive device (671a, 672a).

24. The cable processing apparatus according to claim 16, wherein the third drive device (671a, 672a) is arranged in the tool holder (30), wherein a power supply is preferably provided which is connected to the third drive device (671a, 672a) via hoses (651, 661a, 662a) and preferably a rotary feedthrough (66a) for the hoses (651, 661a, 662a) is provided.

25. The cable processing apparatus according to claim 23, wherein the third drive device (671a, 672a) in the tool holder (30) is designed to be pneumatic, preferably designed as a single-acting pneumatic cylinder.

26. The cable processing apparatus according to claim 16, wherein an adjusting ring (40, 40b) is provided, which can be moved relative to the tool holder (30, 30b) and preferably at least one drive element (551, 552, 551b, 551b) is provided, which is arranged on the adjusting ring (40) or is in operative connection with a surface of the adjusting ring (40).

27. The cable processing apparatus according to claim 16, wherein the cable (80) can be moved relative to the tool holder (30) along the axis of rotation (X).

28. A method for manufacturing a cable (80) with a cable processing apparatus, in particular a cable processing apparatus (20, 20a, 20b) according to one of the preceding claims, comprising at least the following steps:
a) providing a cable (80);
b) rotating a tool holder (30) with a tool holder drive device (34, 34a, 34b) and rotatably processing a sheath and/or a shielding and/or a film of a cable (80) with a group of at least two first tools (351, 352);
c) stopping the tool holder (30) in a predefined position; and
d) processing the cable (80) using at least one second tool (361, 362, 361a, 362a), wherein the at least one second tool (361, 362, 361a, 362a) can be moved independently of the first tools (351, 352) by means of a second drive device (61), wherein the second drive device (61) is arranged in a fixed position on the cable processing apparatus so that it cannot rotate together with the tool holder (30).

29. The method according to claim 28, wherein the at least one second tool (361, 362, 361a, 362a) is located in a first position during step b), and in particular is passively spring-loaded in the first position.

30. The method according to claim 28, wherein after step b) the tool holder (30) is moved relative to the cable (80) along the axis of rotation (X), wherein the first tools (351, 352) are located in a third position.
